(19) United States
(12) Patent Application Publication
(10) Pub. No.: US 2010/0186072 A1
(43) Pub. Date: Jul. 22, 2010

(54) Distributed secure telework

(76) Inventor: Akshay Kumar, Stamford, CT (US)

Correspondence Address: LESTER H. BIRNBAUM, 6 OAKMOUNT COURT, SIMPSONVILLE, SC, 29681, US

(21) Appl. No.: 12/321,416

(22) Filed: Jan. 21, 2009

(51) Int. Cl. H04L 9/32; G09G 5/00; G06F 15/16

(52) U.S. Cl. 726/7; 345/3.1; 709/217

(57) ABSTRACT

The invention provides a method and system for providing distributed secure telework by a plurality of teleworkers. The method includes using non-biometric information to authenticate the plurality of teleworkers, establishing a virtual private network for displaying non-privileged data, providing biometric recognition for displaying privileged data to one or more of a plurality of teleworkers, providing real-time identity validation for the plurality of teleworkers, and facilitating interaction and providing telework capability between an information source and the one or more of the plurality of teleworkers.

### FIELD OF THE INVENTION

The invention relates in general to a method and a system for enabling distributed secure telework. Particularly, the invention relates to the use of a communication device, biometric security measures and a visual display system to enable telework by teleworkers.

### BACKGROUND

For decades, information work has typically been conducted in offices. Offices represent environments where physical and information security controls could be implemented by employers over employees working with confidential information. Three components of cost of traditional offices are: infrastructure costs, such as the costs associated with buildings, lighting, and environmental controls; labor costs, such as the costs associated with workers and management; and social costs, such as cost of commuting to office.

Employers have tried to reduce the costs of these components through various means. In recent years, with broad availability of high-speed networks, telework has become prevalent with increased corporate workers, businesses, and freelancers providing their services from homes. Telework is defined by European Union as “a form of organizing and/or performing work, using information technology, in the context of an employment contract/relationship, where work, which could also be performed at the employer's premises, is carried out away from those premises on a regular basis”. However, current models of telework do not provide sufficient corporate control over teleworker's environment. This limits the type of activities that can be performed by a teleworker. In addition, in recent years, companies have outsourced work to gain economies of scale, or offshored office-based work to remote locations that provide required skills at an attractive labor cost. However, outsourcing and offshoring also suffer from a number of challenges—certain types of work or data cannot be outsourced or offshored, and supply-demand imbalance for attractive skills or locations negatively impacts economics, etc. Moreover, offshored work is often sent to less developed locations with numerous intrinsic security and infrastructure risks. Finally, there are numerous social costs of both office-based environments and offshoring, such as time spent in long commutes, increased carbon footprint, and odd hours of working for offshore workers.

These problems could be addressed if a collaborative, cost-effective teleworking solution could be developed, where a high degree of corporate control could be ensured.

At present, there are several models that enable telework. One of the most common methods is to provide teleworkers with a computer and/or a telephone. However, this method does not provide sufficient visibility to employers on the efforts of teleworkers, with the exception of those tasks where output can be easily measured. Furthermore, in most current telework applications, teleworkers perform as individual contributors, where they lack a sense of team environment, leading to the feelings of isolation with a negative impact on productivity. Finally, there are no mechanisms to ensure that no one other than an authorized teleworker has access to confidential data. Current telework security models focus on restricting types of tasks that could be performed remotely, or limiting or encrypting data that is required to be stored and manipulated remotely.

U.S. Patent Application 2008/0005702 A1 from Skourup et al discloses a method and a computer-based system for configuring, monitoring, and operating a graphical user interface (GUI) in two or three dimensions. Utilizing a Head-mounted Display (HMD), the patent application expands the working GUI area for a user from a screen of information to a three dimensional space. The patent describes the use of this technology in the management of industrial controls.

U.S. Patent Application 2006/0115130 from Douglas Kozlay discloses a mobile, portable, secure eyewear display system that detects user presence to grant privileged users access to secure information, based on verification of biometric and non-biometric information. However, this application does not provide mechanisms for collaboration between users. In addition, the application does not envision the use devices other than an eyewear displays.

In light of the foregoing, there is a need for a collaborative, cost-effective teleworking solution that provides a high level of corporate control.

### SUMMARY

An object of the invention is to provide a method and a system to create a distributed secure teleworking environment.

Another object of the invention is to enable multiple teleworkers to collaborate for telework as a team.

Another object of the invention is to eliminate the need for physical dedicated secure office infrastructure in remote outsourcing locations.

Another object of the invention is to provide the teleworkers with an improved display system to increase their efficiency.

Another object of this invention is to provide teleworkers with means to collaborate effectively as teams and be effectively managed as teams.

Yet another object of this invention is to ensure that only privileged and authorized teleworkers are allowed to access and process information in a remote environment.

Embodiments of the invention provide a method for enabling distributed secure telework. Non-biometric information is used to authenticate teleworkers. A virtual private network for displaying non-privileged data is established. A biometric recognition process for displaying privileged data to teleworkers is provided. A real-time identity validation for the plurality of teleworkers is provided. Interaction between an information source, such as an employer, a service provider or an outsourcer, and a teleworker is enabled. Similarly, interaction among the teleworkers is also enabled, and the information is processed in a secure, distributed, remote environment.

Embodiments of the invention provide a system for enabling distributed secure telework by teleworkers over a virtual private network. Each teleworker is provided with a remote telework station. The remote telework station comprises means for enabling biometric recognition and a means for facilitating real-time identity validation for the teleworkers. The remote telework station further includes a display system and a communication device to enable communication between the teleworkers and an information source, such as a service provider. The communication device enables the transfer of data between the teleworker and the information source over the virtual private network, and also enables interaction among the teleworkers. Moreover, the display system in the remote telework station provides a two or three dimensional physical or virtual extended display, resulting in increased efficiency of the teleworkers.

Embodiments of the invention provide a computer program product for a computer. The computer program product comprises a computer usable medium having a set of instructions stored in a computer readable program code for enabling distributed secure telwork between teleworkers and an information source. Non-biometric information is used to authenticate teleworkers. A virtual private network for displaying non-privileged data is established. A biometric recognition process for displaying privileged data to teleworkers is provided. A real-time identity validation for the plurality of teleworkers is provided. Interaction between an information source, such as a service provider, and the teleworkers is enabled. Similarly, interaction among the teleworkers is also enabled, and the information is processed in a secure, distributed, remote environment.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 is a block diagram illustrating a system for enabling distributed secure telework by a plurality of teleworkers, in accordance with an embodiment of the invention;

FIG. 2 is a block diagram illustrating various components of a remote telework station, in accordance with an embodiment of the invention;

FIG. 3 is a block diagram illustrating various components of a communication device, in accordance with an embodiment of the invention;

FIG. 4 is a block diagram illustrating various system components of an information source, in accordance with an embodiment of the invention;

FIG. 5 is a flowchart illustrating a method for enabling distributed secure telework by a plurality of teleworkers, in accordance with an embodiment of the invention; and

FIGS. 6A and 6B are flowcharts illustrating a method for distributed secure telework by a plurality of teleworkers, in accordance with an embodiment of the invention.

### DETAILED DESCRIPTION OF THE INVENTION

While the preferred embodiments of the invention have been illustrated and described, it will be clear that the invention is not limited to these embodiments only. Numerous modifications, changes, variations, substitutions, and equivalents will be apparent to those skilled in the art without departing from the spirit and scope of the invention as described in the claims.

Embodiments of the present invention provide a method and a system for a distributed secure telework. A teleworker can use a remote telework station to work from any remote location with access to the Internet. A communication device enables communication between teleworkers and an information source. The teleworkers can work collaboratively as a team and can perform various work processes. The system also provides biometric and non-biometric recognition for teleworkers to ensure confidentiality of data.

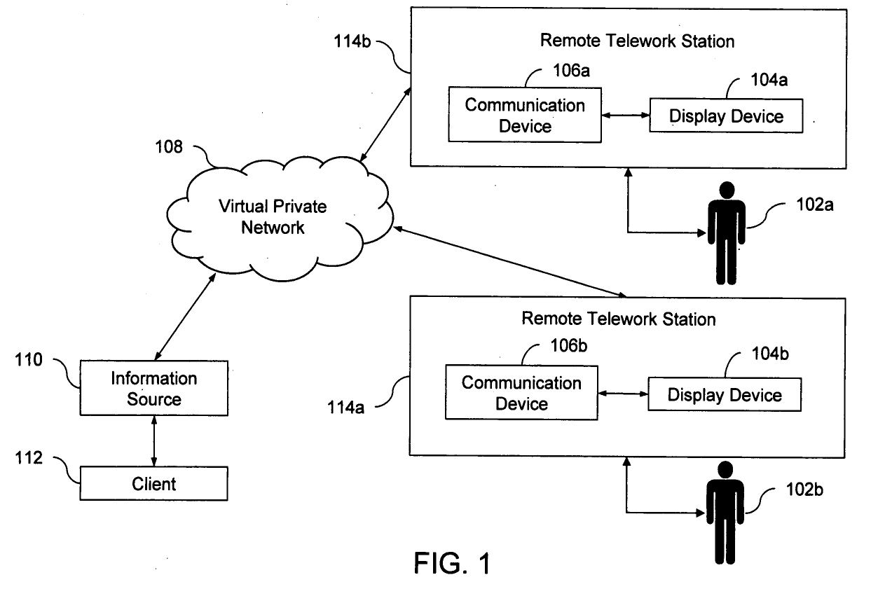

FIG. 1 is a block diagram illustrating a system for enabling distributed secure telework by a plurality of teleworkers, in accordance with an embodiment of the invention. For example, teleworkers 102a and 102b can work for an organization from remote locations. The teleworkers 102a and 102b may be employees of the organization. In other words, at the time of telework, the teleworkers 102a and 102b are not physically present at the employer's premises. The organization acts as an information source 110. The information source 110 can be an organization that desires to get its information processed by its employees, the teleworkers 102a and 102b, situated at remote locations. For example, the information source 110 can be an outsourcing company, which gets the information processed for a client 112. In another embodiment of the invention, the teleworkers 102a and 102b are not employed by an organization, and only process information provided to them by the information source 110. In another embodiment of the invention, the information source 110 is an information repository, which provides information to the teleworkers 102a and 102b who are self-employed.

It will be appreciated by a person skilled in the art that the teleworkers 102a and 102b here are shown for illustrative purpose only, and it does not restrict the scope of the invention in any way. The invention is equally applicable for a number of users 102, corresponding remote telework stations 114, and communication devices 106. The number of teleworkers 102 working for the information source 110 may vary depending on the requirements of the information source 110.

The teleworkers 102a and 102b are provided with remote telework stations 114a and 114b, respectively. In an embodiment of the invention, the remote telework station includes a head mounted device display system. In another embodiment of the invention, the remote telework station includes a multiple screen display system, which includes multiple monitors to display work processes to the teleworkers 102. The display system enables the teleworkers 102a and 102b to view work processes. This is done by providing an extended physical or virtual display by using the display system. In an embodiment of the invention, the head mounted device display system enables an extended virtual display to the teleworker. In another embodiment of the invention, the multiple screen display system enables a physical extended display for the teleworkers. The teleworkers 102a and 102b are provided with user credentials, such as username and password, which they need to input to gain access to a virtual private network (VPN) 108. The VPN 108 enables the teleworkers 102a and 102b to view non-privileged data. Non-privileged data may be in the form of Internet or Intranet websites, user login screens, user support screens, and the like. The transfer of data over the VPN 108 is performed by the communication devices 106a and 106b. A biometric recognition process enables the teleworkers 102a and 102b to also view privileged data over the VPN 108.

Privileged data refers to confidential data at the information source which needs to be kept confidential. For example, a company working in the domain of Intellectual Property will consider invention disclosures and patent applications as confidential data. A call center can consider its customer account details as confidential data, and so forth. The communication devices 106a and 106b enable the teleworkers 102a and 102b to gain access to the VPN 108 between the information source 110 and the teleworkers 102a and 102b. Communication is enabled between the teleworkers 102 and the information source 110 through the VPN 108. The VPN 108 enables the teleworkers 102 to interact among themselves, and also facilitates interaction between the teleworkers 102 and the information source 110. The communication devices 106 are the interface between the information source and the teleworker 102. The communication devices 106 transmit information from the information source on to the display system of the remote telework station.

A biometric recognition process is enabled for the teleworkers 102. The biometric recognition process ensures authenticity of the teleworkers 102 and facilitates the display of privileged data to the teleworkers 102. A validation of teleworkers through non-biometric recognition processes may also be facilitated. In an embodiment of the invention, the validation is conducted at a pre-defined time interval. In another embodiment of the invention, the validation is conducted randomly. The ongoing validation ensures that only authorized users are able to access the privileged data.

The remote telework stations 114a and 114b enable teleworkers 102 to work on processes individually or collaboratively with the other teleworkers. The teleworker 102 uses the remote telework station 114 to view the work related data on an extended physical or virtual display. The teleworker 102 can modify existing data from the information source 110, add new data, or delete unwanted data using various data control, manipulation, and modification devices, such as keyboards and mice.

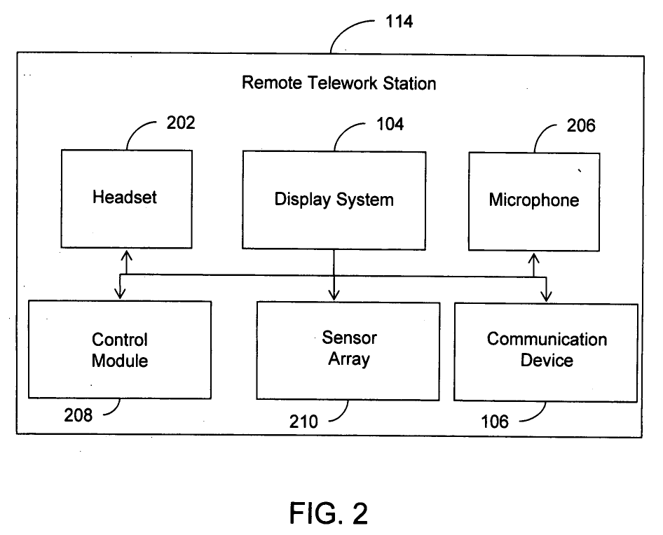

FIG. 2 is a block diagram illustrating various components of a remote telework station 114, in accordance with an embodiment of the invention. The remote telework station 114 comprises a headset 202, a display system 104, a microphone 206, a control module 208, a communication device 106 and a sensor array 210. The display system 204 may be a computer display screen or a head mounted device display system using an LCD panel, CRT tube, LCOS, OLED, Plasma screen or the like.

When a head mounted device display system is used for the display system, the design of the head mounted device display system is customized according to the teleworker's physical characteristics. For example, the head mounted device display system can be customized to permit the teleworker to wear eye glasses. The head mounted device display system can also be customized for individual teleworker's inter-pupillary distance. The headset 202 enables the teleworker to hear conversations between him/her and other teleworkers. In an embodiment of the invention, the headset 202 is a noise canceling headset. The display system 204 renders an extended virtual display for the teleworker 102 on the basis of the teleworker's head movements. The extended virtual display provides a simulated field of view greater than 40 degrees to the teleworker. The extended virtual display gets activated as soon as the teleworker wears the head-mounted device. The head mounted device display system has a limited physical display area. However, the display system 204 can render an extended virtual display with a simulated field of view up to 360 degrees. The teleworker 102 is presented with the rendered extended virtual display at the position where his/her head is turned. For example, the teleworker 102 can be provided with three virtual displays, namely A, B, and C. The teleworker 102 can view information on the virtual display A when his/her head is pointed toward the left. The teleworker 102 can view information on the virtual display B when his/her head is pointed toward the center. Likewise, the teleworker 102 can view the information on the extended virtual display C, when his/her head is pointed toward the right.

In the event a multiple screen display system is used; for example, the teleworker 102 can be provided with three physical computer displays, namely A, B, and C, where he/she is able to view different images. A teleworker may elect to use as many displays as spatially feasible.

It will be appreciated by a person skilled in the art that the displays A, B, and C are explained here for illustrative purposes only, and it does not restrict the scope of the invention in any way. The invention is equally applicable for a number of such displays that are rendered on the basis of the head movements of the teleworker 102.

When a head mounted device display system is used by the teleworker 102, a motion sensor or a degrees of freedom (DOF) sensor is used to detect the head movements of teleworker 102. The motion sensor or a DOF sensor is part of the sensor array 210. The display system 104 uses existing display technology to create a simulated field of view up to 360 degrees for the teleworker 102. The display system 204 used to enable physical or virtual display can be made by using Organic Light Emitting Diodes (OLED), Liquid Crystal Displays (LCD), Retinal Projection Systems, and the like. Various examples of such virtual displays are known in the art. The display system 104 functions like a virtual computer screen and the teleworker 102 can view work processes and other information on the rendered extended virtual display.

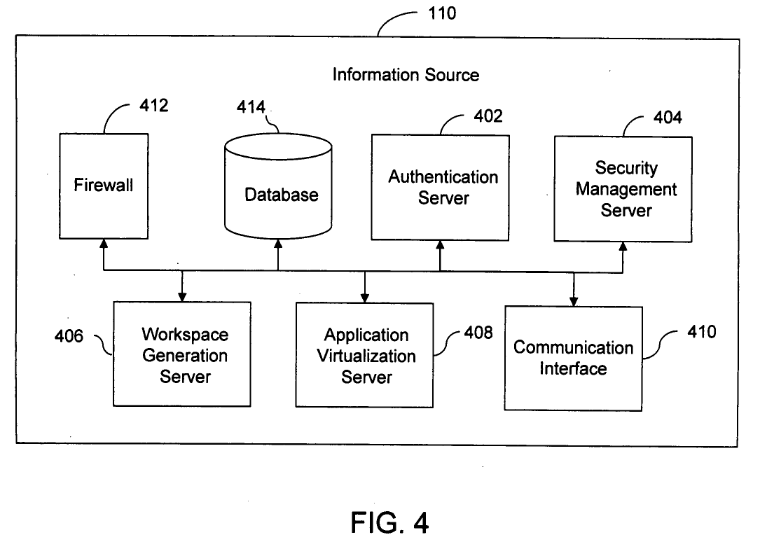

The remote telework station 114 also comprises a microphone 206. The microphone 206 can be used by the teleworker 102 to speak with other teleworkers. In an embodiment of the invention, speech recognition software is provided to convert speech based commands from the teleworker 102 into text. The software runs at the information source, details of which are discussed in detail in conjunction with FIG. 4. The microphone 206 can act as an input device in this case.

The control module 208 controls the functioning of the headset 202, the display system 104, the microphone 206, and the sensor array 210. The sensor array 210 may include sensors for facial recognition, iris recognition, retinal recognition, voice recognition, fingerprint scanning, keystroke pattern recognition, DNA sampling, and brain activity pattern recognition, and in the event a head mounted device display system is used, degrees of freedom sensors. The degrees of freedom sensors help detect the direction where the user's head is pointed in order for the communication device to render or sharpen the portion of the extended virtual display where the teleworker 102 is focusing. For example, if the teleworker 102 is focusing on the left side of the extended virtual display, then the sharpness of the image on the left side of the extended virtual display is increased. In another embodiment of the invention, a gaze tracking system may be used to achieve similar functionality. The functioning of the sensor array 210 is controlled by the control module 208. In another embodiment of the invention, the sensor array 210 includes sensors to detect the teleworker's presence. This enables the display system to be activated based on the teleworker's proximity. For example, the display system provided in a head mounted device display system will be activated as soon as the teleworker 102 puts on the head mounted device display system. The sensors included in the sensor array 210 are primarily used for sensing the teleworker's biometric information, proximity or movements. The biometric recognition process, which is carried out at the information source 110, is explained in detail in the discussion below.

When a multiple screen display system is used as the remote telework station, one or more cameras can be used for facial recognition of the teleworkers 102a and 102b. The cameras can also be used to take snapshots of the teleworker's iris and use it for the iris recognition process.

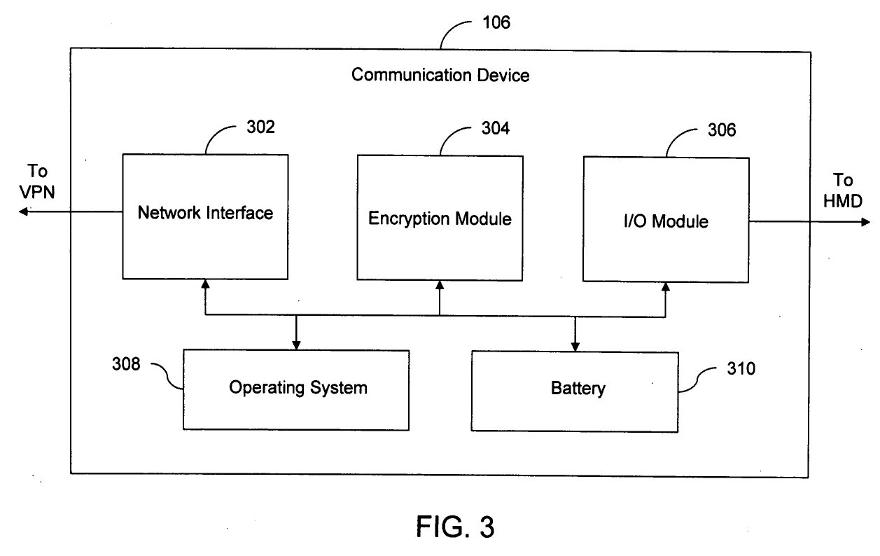

FIG. 3 is a block diagram illustrating various components of a communication device 106, in accordance with an embodiment of the invention. The communication device 106 comprises a network interface 302, an encryption module 304, an I/O module 306, an operating system 308, and a battery 310.

The communication device 106 enables the biometric and non-biometric recognition processes. The communication device 106 also enables communication between the teleworkers 102, and the communication between the information source 110 and the teleworkers 102. The network interface 302 is connected through the VPN 108 to the information source 110. The connection between the network interface 302 and the VPN 108 can be wired or wireless. The network interface 302 obtains privileged and non-privileged data from the information source 110 and displays it through the display system 104 to the teleworker 102. The network interface 302 also transfers data from the teleworker 102 back to the information source 110.

In an embodiment of the invention, the data from the information source 110 to be displayed to the teleworker 102 is encoded in a format which can be displayed on the display system 104 by the encryption module 304. The data which is transferred from the teleworker 102 to the information source 110 is also encoded by the encryption module 304 in a format which is recognized by the information source 110.

The I/O module 306 is an input-output interface known in the art. The I/O module 306 interfaces with the display device 104 and obtains the biometric inputs from various sensors explained in conjunction with FIG. 2. Connections from I/O module 306 to other devices are preferably physically and electromagnetically shielded to prevent physical or electronic tampering. Various I/O devices, such as keyboard, mouse, scanner, speech recognition software, and joystick, can be connected to the I/O module 306 via wires or wireless means.

The operating system 308 manages different activities in the communication device 106. The activities refer to transfer of data between the information source 110 and teleworker 102, functioning of network interface 302, functioning of the encryption module 304, and other standard functions carried out by an operating system. The operating system 308 also shares hardware resources of the communication device 106. That is, the operating system 308 allocates resources to the various components of the communication device 106 to ensure proper functioning of the communication device 106.

In an embodiment of the invention, the communication device 106 obtains electric power for its operation from an international standard power outlet. In another embodiment of the invention, the communication device 106 has a stand-by battery 310 which provides the power for its operation for a limited time.

FIG. 4 is a block diagram illustrating various system components at the information source 110, in accordance with an embodiment of the invention. The information source 110 comprises an authentication server 402, a security management server 404, a workspace generation server 406, an application virtualization server 408, a communication interface 410, a firewall 412, and a database 414.

The authentication server 402 authenticates teleworkers by using biometric or non-biometric means. In case of a non-biometric recognition process, the teleworker 102, in an embodiment of the invention, is prompted to enter a username and password to validate him/her. The authentication server 402 checks this information with the user details stored in the database 414, and validates the teleworker 102. Biometric recognition can be one of facial recognition, iris recognition, retinal recognition, voice recognition, fingerprint scanning, keystroke pattern recognition, DNA sampling, and brain activity pattern recognition, and so forth. The authentication server 402 matches biometric and non-biometric information obtained by the I/O module 306 with the teleworker personal information present in the database 414. In case of biometric recognition, sensors included in the sensor array 210 scan the teleworker's iris, retina, or fingerprint, or takes a DNA sample of the teleworker 102.

Once authenticated, the teleworker 102 is able to view and process privileged information from the information source 110. The security management server 404 runs an algorithm that determines the authentication validation requirements for an individual teleworker. The algorithm takes into account security requirements expressed by the client 112, location of teleworker, duration of teleworker's work session, tenure of teleworker, and so on and directs authentication server 402 to obtain one or more biometric or non biometric authentication inputs from the teleworker. Authentication validation algorithms include safeguards to detect presence of persons other than authorized users in proximity of the remote telework station. For example, the authentication validation algorithm can be tuned to monitor the presence of multiple faces. In an embodiment of the invention, a warning message is displayed to the teleworker 102 indicating that an unauthorized person is in the proximity of his/her remote telework station 114.

The workspace generation server 406 generates and transmits information to be displayed by the remote telework station 114. The application virtualization server 408 runs virtualized versions of information source or client applications, such as email clients, intranet browsers, instant messengers, collaborative tools, various applications, and so on. The workspace generation server 406 organizes these virtual applications for use by appropriate physical or virtual extended display and sends this data to the teleworker 102. The communication devices at teleworkers' location are preferably not provided access to any non-virtualized data stored at the information source 110. The teleworkers 102 only get to view and work upon the virtual or rasterized version of the data.

The process of providing virtual data to the teleworker 102 elevates the safety of information transfer and maintains confidentiality of privileged data. An example of such a system is a CITRIX® system, which provides virtualization and application networking solutions. In the CITRIX® system, an application runs on a server and the application screenshots are sent to the teleworker's computer. In return, their keyboard inputs and mouse movements are sent to the CITRIX® Server. This process is both bandwidth-efficient and inherently more secure, as application data is not transmitted to the teleworkers.

The communication interface 410 communicates with the communication device 106 at the teleworker's end. The communication interface 410 is also responsible for transferring data from the information source to the teleworker 102. The firewall 412 is an integrated collection of security measures designed to prevent unauthorized access to data at the information source 110. The firewall 412 is configured to deny, encrypt, decrypt, or proxy teleworker access, based upon a set of rules and criteria.

The database 414 contains teleworker information. In an embodiment of the invention, the database can contain data pertaining to all users/employees of the information source 110. The database 414 also contains information such as the username and password assigned to the teleworkers 102. The database 414 may also contain user confidential information such as user's employment records.

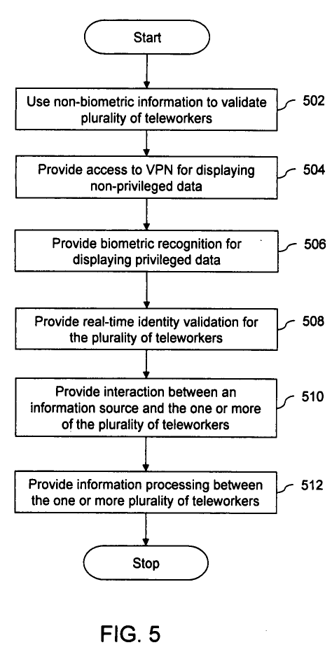

FIG. 5 is a flowchart illustrating a method for enabling distributed secure telework by a plurality of teleworkers 102, in accordance with an embodiment of the invention. At step 502, non-biometric information is used to validate a teleworker 102. In an embodiment of the invention, the non-biometric validation process can be login credentials assigned to the teleworker 102 by the information source 110. In another embodiment of the invention, the teleworker 102 can also be provided with time-based tokens or RSA® keypads to login to the information source 110. At step 504, the teleworker 102 is provided access to a virtual private network (VPN) present between the information source 110 and the remote telework station 114. The VPN 108, at this stage, enables teleworker 102 to access non-privileged data only.

At step 506, biometric recognition process is provided for the teleworkers 102. The biometric recognition process can be one of facial recognition, iris recognition, retinal recognition, voice recognition, fingerprint scanning, keystroke pattern recognition, DNA sampling, brain activity pattern recognition, and so forth. Once the teleworker 102 is validated through the use of a biometric recognition process, the teleworker 102 is given access to privileged data. Privileged data refers to information which is confidential to the information source.

At step 508, a real-time identity validation is provided for the teleworker 102. The real-time identity validation is an on-going process, and ensures that unauthorized access to privileged data is prevented. For real-time identity validation, the security management server 404 runs an algorithm that determines the authentication validation requirements for an individual teleworker. The security management server 404 directs the authentication server 402 to obtain one or more biometric or non biometric authentication inputs from the teleworker.

In an embodiment of the invention, the authentication server 402 determines and manages frequency, interval and type of validation processes based on security requirements. In an embodiment of the invention, the real-time identity validation process occurs at a pre-defined time interval. In another embodiment of the invention, the real-time validation process occurs randomly. At step 510, interaction between the plurality of teleworkers 102 and the information source 110 is provided. Interaction is also provided between the teleworkers 102. At step 512, telework is enabled between the teleworkers 102. For example, the teleworkers are provided with a virtual excel workbook. Individual teleworkers can work on different sheets of the workbook. The remote telework station enables team work between teleworkers by providing a remote platform on which individual teleworkers can collaborate as a group.

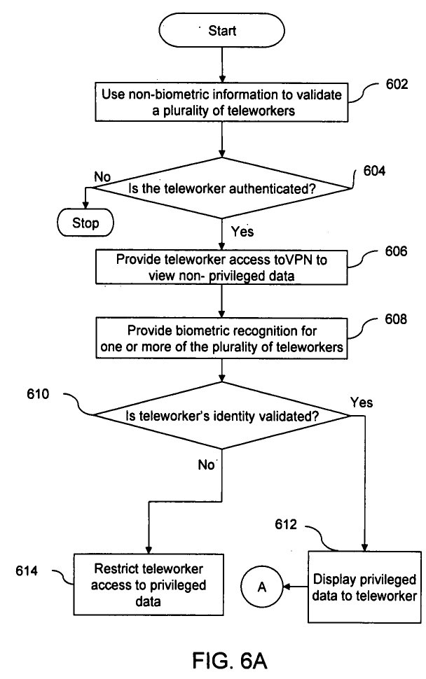

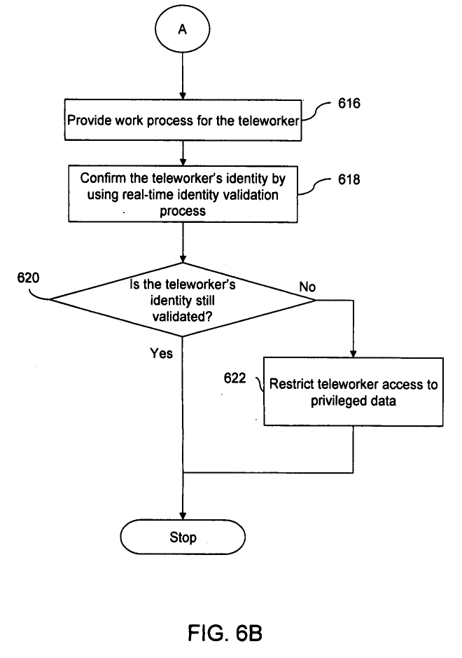

FIGS. 6A and 6B are flowcharts illustrating a method for distributed secure telework by a plurality of teleworkers 102, in accordance with an embodiment of the invention. At step 602, non-biometric information is used to validate a teleworker 102. After his proximity is sensed, the teleworker 102 may be prompted to enter a username and password to validate his/her identity. At step 604, the information entered by the teleworker 102 is transmitted to the authentication server 402, where it is checked with the information present in the database 414 to validate the authenticity of the teleworker 102. At step 606, a VPN 108 is established to display non-privileged data to the teleworker 102.

At step 608, biometric recognition is provided for teleworkers 102. In an embodiment of the invention, an authentication server 402 conducts various biometric and non-biometric authentication processes. If the teleworker 102 is successfully authenticated, teleworker 102 can access privileged data. Biometric recognition can be one of facial recognition, iris recognition, retinal recognition, voice recognition, fingerprint scanning, keystroke pattern recognition, DNA sampling, brain activity pattern recognition, and so forth.

At step 610, the teleworker's biometric identity is checked against the database 414 containing the teleworker's personal information. If the teleworker 102 is validated through the use of the biometric recognition process, the teleworker 102 can access privileged data at step 612. Privileged data refers to information which is confidential to the information source, as explained earlier. If the teleworker 102 is not validated through the use of a biometric recognition process, the access to privileged data is denied to the teleworker 102 at step 614.

At step 616, the workspace generation server 406 provides work processes for the teleworker. For example, a virtual excel spreadsheet is displayed to the teleworker 102 on his/her remote telework station's display system. The teleworker 102 can work on the virtual excel spreadsheet by making edits, additions and any modifications required. The changes made by the teleworker 102 will be reflected at the information source. In an embodiment of the invention, the workspace generation server 406 generates and transmits extended physical or virtual display to the remote telework station 114 through communication device 106. The teleworkers 102 can work on the virtual workspaces provided by the workspace generation server 406 collaboratively with the other teleworkers. The teleworker 102 can make edits, additions, and deletions within the virtual workspaces provided and perform telework for the information source 110.

At step 618, an on-going validation process occurs for the teleworker 102. As explained in conjunction with FIG. 5, the on-going validation can be biometric or non-biometric in nature. The on-going validation is performed as a security measure to ensure the ongoing authenticity of the teleworker. At step 620, the teleworker response to the on-going validation is checked against the teleworker's personal information contained in the database 414. At step 622, access to privileged data is restricted if the teleworker 102 is not validated at any point of time through the on-going validation process.

An advantage of the invention is that it enables telework by teleworkers situated at different locations. Another advantage of the invention is that it maintains confidentiality of privileged data by facilitating numerous security checks unobtrusively on the teleworkers, i.e. the invention provides a high-level of corporate control over the teleworkers' environment. Yet another advantage of the invention is that it provides the teleworkers with a sense of working as a team and also increases their efficiency by using the extended physical or virtual display.

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, and a display unit. The computer typically comprises a microprocessor. The microprocessor is connected to a communication bus. The computer also includes a memory. The memory may include Random Access Memory (RAM) and Read Only Memory (ROM). The computer system further comprises a storage device. It can be a hard disk drive or a removable storage drive such as a floppy disk drive, optical disk drive and the like. The storage device can also be other similar means for loading computer programs or other instructions into the computer system.

The computer system executes a set of instructions that are stored in one or more storage elements in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

What is claimed is:

1. A method for providing distributed secure telework, the method comprising:
using non-biometric information to authenticate a plurality of teleworkers;
providing the plurality of teleworkers access to a virtual private network for viewing non-privileged data;
providing biometric recognition for displaying privileged data to the plurality of teleworkers;
providing real-time identity validation for the plurality of teleworkers;
providing interaction between an information source and the plurality of teleworkers; and
providing telework capability to the plurality of teleworkers.

2. The method of claim 1, wherein the non-biometric information comprises user credentials.

3. The method of claim 1 further comprising providing communication between the plurality of teleworkers over the virtual private network.

4. The method of claim 1, wherein the biometric recognition is selected from a group of biometric recognition processes consisting of facial recognition, iris recognition, retinal recognition, voice recognition, fingerprint scanning, keystroke pattern recognition, DNA sampling, and brain activity pattern recognition.

5. The method of claim 1 further comprising providing a two or three dimensional extended virtual display for the plurality of teleworkers.

6. The method of claim 5 further comprising providing the plurality of teleworkers a simulated field of view up to 360 degrees.

7. The method of claim 5 further comprising increasing sharpness of the extended virtual display in an area of focus of the plurality of teleworkers.

8. The method of claim 1 further comprising providing one or more physical displays to the plurality of teleworkers.

9. A system for providing distributed secure telework between a plurality of teleworkers over a virtual private network, the system comprising, for a teleworker from the plurality of teleworkers:
a remote telework station comprising:
a sensor array for enabling biometric recognition for the teleworker;
a control module for facilitating real-time identity validation for the plurality of teleworkers;
a display system; and
a communication device for establishing communication between the teleworker and an information source, the communication device comprising:
a network interface for transferring data between the teleworker and the information source over the virtual private network.

10. The system of claim 9, wherein the remote telework station further comprises one or more data control, manipulation and modification devices.

11. The system of claim 9, wherein the remote telework station further comprises one or more of a microphone, a noise canceling headset, and means for adjusting the display system for physical characteristics of the teleworker.

12. The system of claim 9, wherein the sensor array is capable of obtaining biometric recognition inputs for at least one of facial recognition, iris recognition, retinal recognition, voice recognition, fingerprint scanning, keystroke pattern recognition, DNA sampling, and brain activity pattern recognition.

13. The system of claim 9 further comprising, at an information source:
a firewall for preventing unauthorized access to the information source;
a database for maintaining the teleworker authentication information;
an authentication server for authenticating the plurality of teleworkers;
a security management server for validating identity of the plurality of teleworkers;
a workspace generation server for generating a two or three dimensional virtual workspace for the plurality of teleworkers;
an application virtualization server for providing one or more applications to the plurality of teleworkers; and
a secure connection for establishing communication with one or more clients.

14. A computer program product for use with a computer, the computer program product comprising a set of instructions stored in a computer usable medium having a computer readable program code embodied therein for enabling a distributed secure telework between a plurality of teleworkers and an information source, the set of instructions performing:
using non-biometric information to authenticate a plurality of teleworkers;
providing the plurality of teleworkers access to a virtual private network for viewing non-privileged data;
providing biometric recognition for displaying privileged data to the plurality of teleworkers;
providing real-time identity validation for the plurality of teleworkers;
providing interaction between an information source and the plurality of teleworkers; and
providing telework capability between the plurality of teleworkers.

15. The computer program product of claim 14, wherein non-biometric information comprises user credentials.

16. The computer program product of claim 14 further comprising providing communication between the plurality of teleworkers over the virtual private network.

17. The computer program product of claim 14, wherein the biometric recognition is selected from the group of biometric recognition processes consisting of facial recognition, iris recognition, retinal recognition, voice recognition; fingerprint scanning, keystroke pattern recognition, DNA sampling, and brain activity pattern recognition.

18. The computer program product of claim 14 further comprising providing a two or three dimensional extended virtual display for the plurality of teleworkers.

19. The computer program product of claim 18 further comprising providing the plurality of teleworkers a simulated field of view up to 360 degrees.

20. The computer program product of claim 18 further comprising increasing sharpness of the virtual display in an area of focus of the plurality of teleworkers.

21. The computer program product of claim 14 further comprising providing one or more physical displays to the plurality of teleworkers.
